(19) United States
(12) Patent Application Publication
(10) Pub. No.: US 2005/0233785 A1
(43) Pub. Date: Oct. 20, 2005

(54) Portable communication apparatus having pop-up type display device

(75) Inventors: Bum-Soo Park, Gwangmyeong-si (KR); Jong-Seong Lee, Seoul (KR); Beom-Ku Han, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/012,976

(22) Filed: Dec. 15, 2004

(30) Foreign Application Priority Data
Apr. 14, 2004 (KR) 25720/2004

(51) Int. Cl. H04M 1/00

(52) U.S. Cl. 455/575.4; 455/575.1

(57) ABSTRACT

A sliding-type portable communication apparatus, which has an pop-up type display device, including a first housing; a second housing adapted to slide on the first housing along the longitudinal direction thereof; and a display device having a first region, which is exposed or concealed according to the position of the second housing, and a second region, which is disposed adjacently to the first region and which remains exposed regardless of the position of the second housing, the display device being adapted to advance or retract in a direction perpendicular to the upper surface of the first housing, while remaining in a plane to the upper surface of the first housing.

### PRIORITY

This application claims priority to an application entitled “Portable Communication Apparatus Having Automatic Sliding Pop-Up Type Display Device” filed with the Korean Intellectual Property Office on Apr. 14, 2004 and assigned Serial No. 2004-25720, the contents of which are hereby incorporated by reference.

### BACKGROUND OF THE INVENTION

1. Field of the Invention

The present invention relates to portable communication apparatuses, including cellular phones, PDAs (personal digital assistants), HIPs (hand held phones), portable communication apparatuses for game, and digital communication apparatuses, and more particularly to a portable communication apparatus having a display device adapted to perform automatic sliding pop-up motion according to the opening/closing of the apparatus.

2. Description of the Related Art

In general, a “portable communication apparatus” refers to an electronic apparatus which a user can carry with him to perform wireless communication with a desired partner. In consideration of portability, designs of such portable communication apparatuses tend to be compact, slim, and light, and also include multimedia availability, and a wide variety of functions. In particular, future portable communication apparatuses are expected to incorporate greater multi-functionality and multi-purpose utilization, as well as being more compact and light, but also will be modified to be suitable for various multimedia environments or Internet environments. Additionally, such portable communication apparatuses are now commonly used throughout the world, and are considered an indispensable part of everyday life.

Conventional portable communication apparatuses may be classified into various types according to their appearance, such as bar-type portable communication apparatuses, flip-type portable communication apparatuses, and folder-type portable communication apparatuses. The bar-type portable communication apparatus has a single housing shaped like a bar. The flip-type portable communication apparatus has a flip which is pivotably mounted to a bar-shaped housing by a hinge device. The folder-type portable communication apparatus has a folder coupled to a single bar-shaped housing by a hinge device in such a manner that the folder can be rotated in order to be folded towards and unfolded away from the housing.

Further, portable communication apparatuses may be classified into neck wearable type communication apparatuses and wrist wearable type communication apparatuses according to the position at or the way in which a user puts on the communication apparatus. The neck wearable type communication apparatus is one which a user wears around the neck using a string or lanyard, while the wrist wearable type communication apparatus is one which a user wears around the wrist.

Additionally, portable communication apparatuses may be further classified as rotation-type communication apparatuses and sliding-type communication apparatuses based upon the way of opening and closing the communication apparatuses are performed. In the rotation-type portable communication apparatus, two housings are coupled to each other to allow one housing to rotate open or closed relative to the other while facing each other. In the sliding-type portable communication apparatus, two housings are coupled to each other to allow one housing to slide along a longitudinal direction to open or close the sliding-type portable communication apparatus. These variously classified portable communication apparatuses can be easily understood by those skilled in the art.

Meanwhile, conventional portable communication apparatuses now tend to have a function of transmitting data at a high speed in addition to the basic function of performing voice communication. In other words, according to the increased demand by consumers, portable communication apparatuses now tend to provide a service using a wireless communication technology capable of transmitting data at a high speed.

Recent portable communication apparatuses also tend to be equipped with a camera lens which enables each of the communication apparatuses to transmit an image signal. That is, current conventional portable communication apparatuses may have an external or imbedded camera lens module which enables a user to transmit an image to a desired partner or to take a photograph of a desired subject.

In addition, conventional portable communication apparatuses necessarily have data input/output devices, data transmission/reception units, an antenna device, and the like, which are positioned on the body thereof at suitable locations. The data input device generally incorporates an LCD, and the data output device generally incorporates a keypad composed of a plurality of keys.

However, conventional sliding-type portable communication apparatuses suffer from the problem of limited convenience, because the data input/output devices, i.e., the LCD and the keypad, are fixedly mounted on the apparatuses; specifically, they are contained in the main housing. For example, Korean Patent Application No. 2002-71911 (the contents of which are hereby incorporated by reference) filed in the name of the present assignee discloses an apparatus having a keypad, which includes a plurality of keys, fixedly positioned on a body and an LCD mounted on a sliding body. In this apparatus, the LCD is protected when the apparatus is dropped or when it is not in use. In addition, since the LCD is always exposed, the surface thereof is vulnerable to contamination and scratching, when the apparatus is carried or stored in a pocket or a bag.

### SUMMARY OF THE INVENTION

Accordingly, the present invention has been made to solve the above-mentioned problems occurring in the prior art, and an object of the present invention is to provide a portable communication apparatus having an automatic sliding pop-up type display device.

Another object of the present invention is to provide a portable communication apparatus capable of minimizing damage to its LCD, when the apparatus is dropped, and capable of protecting the surface of the LCD, when the apparatus is carried.

In order to accomplish this object, there is provided a sliding-type portable communication apparatus including a first housing; a second housing adapted to slide on the first housing along the longitudinal direction thereof; and a display device having a first region, which is exposed or hidden according to whether the second housing is slid open or not, and a second region, which is disposed adjacently to the first region and which remains exposed regardless of whether the second housing is slid open or not, the display device being adapted to protrude or retract in a direction perpendicular to the upper surface of the first housing, while remaining in a plane parallel to the upper surface of the first housing, according to whether the second housing is slid open or not so that the level difference between the upper surface of the first housing and that of the display device can be compensated for.

In accordance with another aspect of the present invention, there is provided a sliding-type portable communication apparatus including a first housing; a second housing adapted to slide on the first housing along the longitudinal direction thereof; and a display device adapted to advance upwards along a direction perpendicular to the upper surface of the first housing and to retract downward along a direction perpendicular to the upper surface of the first housing, while remaining in a plane parallel to the upper surface of the first housing, according to whether the second housing is slid open or not so that the level difference between the upper surface of the first housing and that of the display device can be compensated for.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a portable communication apparatus having an automatic sliding pop-up type display device according to a first preferred embodiment of the present invention;

FIG. 2 is a perspective view showing a state wherein the second housing shown in FIG. 1 has slid open a predetermined distance;

FIG. 3 is a perspective view showing a state wherein the second housing shown in FIG. 1 is completely slid open and the display device has completely popped up; and

FIGS. 4A to 4C are side views showing the pop-up opening/closing procedure of a display device according to a first preferred embodiment of the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

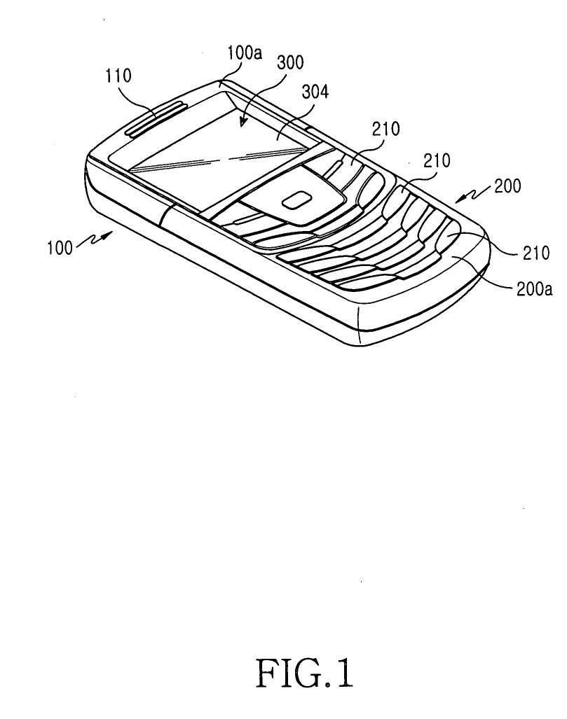

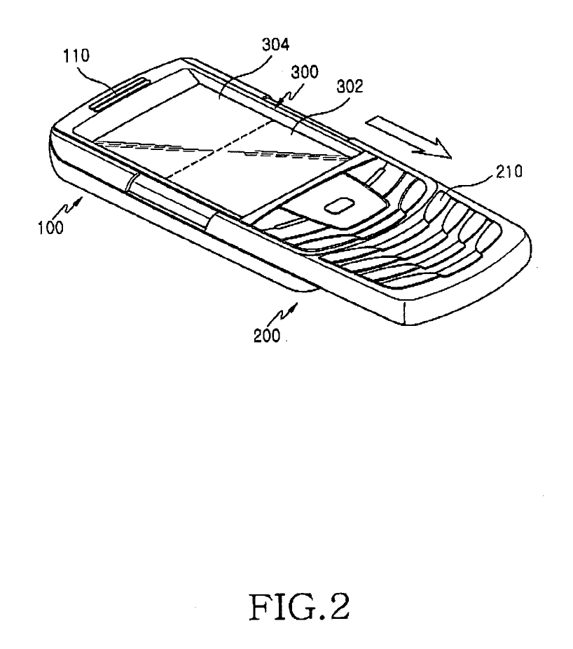

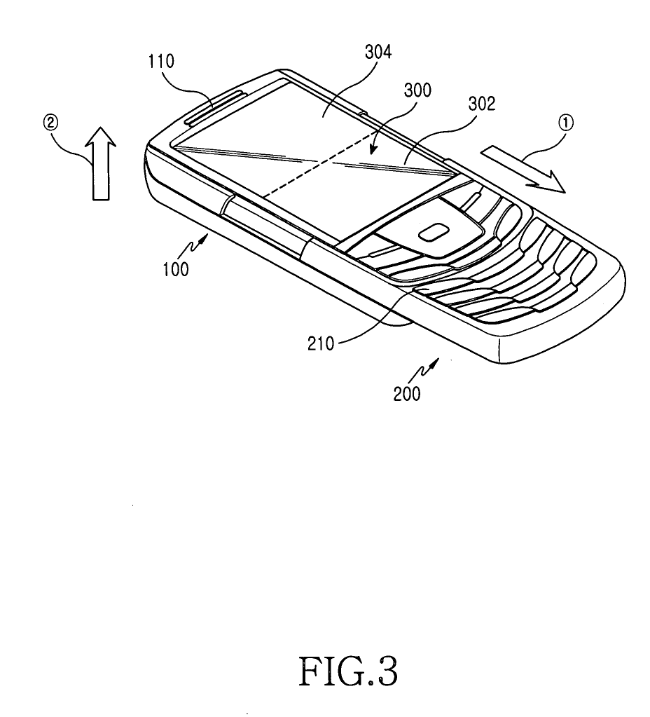

As shown in FIGS. 1 to 3, a portable communication apparatus according to the present invention includes a first housing 100, a second housing 200, and a display device 300 adapted to pop up or advance upwards when the second housing 200 is opened, and retract downwards when the second housing 200 is closed, in a direction perpendicular to the upper surface of the first housing 100. More specifically, the portable communication apparatus according to the present invention includes a first housing 100, a second housing 200 adapted to slide on the first housing 100 along the longitudinal direction thereof (indicated by arrow \mathring{1} in FIGS. 2 and 3), and a display device 300 having a first region 302, which is concealed when the second housing 200 is slid closed as in FIG. 1, and which is exposed when the second housing 200 is slid open as in FIGS. 2 and 3, and a second region 304, which is disposed adjacently to the first region 302 and which is remains exposed regardless of the position of the second housing 200. The display device 300 is adapted to advance upwards and retract downwards in a direction (indicated by arrow \mathring{2} in FIG. 3) perpendicular to the upper surface 100a of the first housing 100, while remaining in a plane parallel to the upper surface 100a of the first housing 100, according to whether the second housing 200 is slid open or closed so that the display device advances upwards substantially to the level of the upper surface of the first and second housings when the second housing is opened, and the display device retracts down into the second housing when the second housing is closed. The display device 300 is continuously positioned in a plane parallel to the upper surface 100a of the first housing when it advances upwards or retracts downwards. The advancing and retracting of the display device may be referred to as “pop-up” motion. The display device 300 advances upwards in a direction perpendicular to the upper surface 100a of the first housing, and retracts downwards in a direction perpendicular to the upper surface 100a of the first housing. The display device 300 can advance within the first housing 100 only after a complete sliding movement of the second housing 200.

Preferably, the upper surface of the display device 300 is flush with the keypad 210 of the second housing when the display device 300 has completely advanced. Although the upper surface of the display device 300 may slightly protrude from the keypad 210 of the second housing, it is preferable to minimize the height difference between them. This is because a user can input data or watch inputted data being displayed on the screen in a convenient manner when the display device 300 and the keypad 210 are positioned planar to each other. The first housing 100 has a speaker device 110 positioned on its upper surface 100a. The second housing 200 has a keypad 210 having a plurality of keys positioned on its upper surface 200a.

The display device 300 has it upper surface configured as a display region. The display device 300 is adapted to pop up, i.e., to advance or retract while remaining in a horizontal orientation. It is to be noted that the display device 300 may have an automatic, manual, or semi-automatic power source for such advancing or retracting.

As described above, the display device 300 has a display region composed of a first region 302 and a second region 304 disposed adjacently to the first region 302. The first region 302 is selectively exposed according to whether the keypad 210 is slid open or closed, while the second region 304 remains exposed regardless of the position of the keypad 210. Accordingly, the second region 304 generally displays information which must be checked frequently, for example, data on time, date, reception sensitivity of antenna, charging level of battery, and arrival of message. The display device 300 may incorporate a conventional LCD or a touch screen. The upper surface of the display device 300 is spaced from the upper surface of the keypad 210, during a standby mode as shown in FIG. 1 or during power-off, so that the surface of the display device 300, i.e., the first and second regions 302 and 304, can be protected.

When the display device 300 has a semi-automatic power source, the lower end of the display device 300 is slanted for contact with the upper end of the second housing 200, as well as for smooth sliding after the contact. Although not shown in the drawing, the semi-automatic power source of the display device 300 may be an elastic member, e.g., a coil spring. If a user wants to close the second housing 200 when the display device 300 has completely popped up, he can forcibly press the display device 300 and slide the second housing 200 to close it. Meanwhile, the display device 300 may have an automatic power source, such as a conventional motor and a reduction module.

As shown in FIG. 1, when the second housing 200 is closed on the first housing 100, the speaker device 110, the second region 304, and the keypad 210 are disposed adjacently to one another in series.

As shown in FIG. 3, when the second housing 200 is completely slid away from the first housing 100, the speaker device 110, the second region 304, the first region 302, and the keypad 210 are disposed adjacently to one another in series.

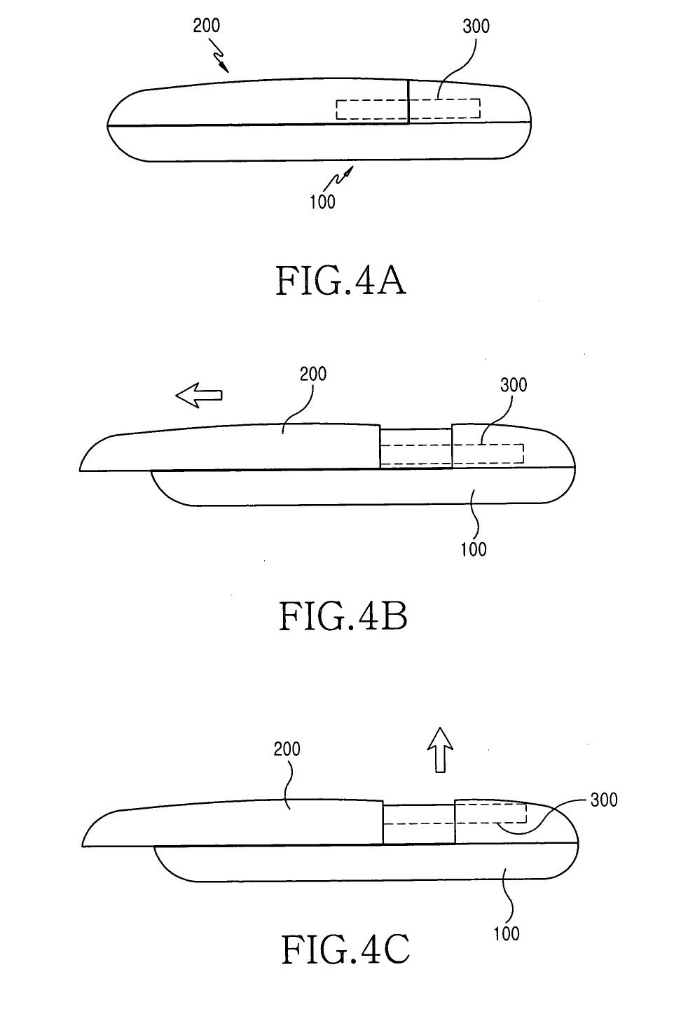

FIGS. 4A to 4C briefly show the pop-up procedure of the display device 300 according to the present invention. As shown in the drawings, the pop-up procedure is preferably performed in three stages. First, the second housing 200 is completely closed as shown in FIG. 4A. As the second housing 200 is slid open, the first region 302 of the display device begins to advance upwards towards the upper surface of the first and second housings 100 and 200 as the second housing is slid (indicated by arrow \mathring{1}, as shown in FIG. 4B. The second housing 200 is fully opened and the first region 302 of the display device is fully advanced upwards and ready for use as shown in FIG. 4C. FIG. 4A shows a standby mode or power-off and FIG. 4C a speech or communication mode.

As mentioned above, the portable communication apparatus according to the present invention is advantageous in that it is possible to minimize the damage or scratch on the display device when the apparatus is dropped, the surface of the display device can be protected when the apparatus is carried, and the display device is adapted to pop up for convenient use.

While the invention has been shown and described with reference to certain preferred embodiments thereof, it will be understood by those skilled in the art that various changes in form and details may be made therein without departing from the spirit and scope of the invention as defined by the appended claims.

1. A sliding-type portable communication apparatus comprising:
a first housing;
a second housing adapted to slide on the first housing along the longitudinal direction thereof; and
a display device having a first region, which is exposed and concealed upon a sliding movement of the second housing, and a second region, which is disposed adjacent to the first region and remains exposed regardless of the position of the second housing, the display device adapted to advance upwards and retract downwards in a direction perpendicular to an upper surface of the first housing, while remaining in a plane parallel to the upper surface of the first housing.

2. A portable communication apparatus as claimed in claim 1, wherein the first housing has a speaker device positioned on its upper surface, and the second housing has a keypad having a plurality of keys provided on its upper surface.

3. A portable communication apparatus as claimed in claim 2, wherein the speaker device, the second region, and the key pad are disposed adjacent to one another in series, when the second housing is closed on the first housing, and the speaker device, the second region, the first region, and the keypad are disposed adjacent to one another in series, when the second housing is completely slid away from the first housing.

4. A portable communication apparatus as claimed in claim 1, wherein the sliding movement of the second housing to a fully open position results in the advancement of the display device to be substantially planar with the upper surface of the first housing.

5. A sliding-type portable communication apparatus comprising:
a first housing;
a second housing adapted to slide on the first housing along the longitudinal direction thereof; and
a display device adapted to advance upwards along a direction perpendicular to an upper surface of the first housing and to retract downwards along a direction perpendicular to the upper surface of the first housing, while remaining in a plane parallel to the upper surface of the first housing, the upwards and downwards motion controlled by a sliding motion of the second housing.

6. A portable communication apparatus as claimed in claim 5, wherein the display device is adapted to advance upon fully sliding the second housing away from the first housing.

7. A portable communication apparatus as claimed in claim 5, wherein the upper surface of the display device is in the same plane as the upper surface of the second housing when the display device has completely advanced.
